(19) United States
(12) Patent Application Publication
(10) Pub. No.: US 2021/0150491 A1
(43) Pub. Date: May 20, 2021

(54) Method for Improving Complexity of Mechanical Device Maintenance System

(71) Applicant: Jianquan ZHOU, Jilin (CN)

(72) Inventors: Jiwu SUN, Jilin (CN); Qinghua LIANG, Guangdong (CN); Zumin WANG, Liaoning (CN); Enning ZHANG, Jilin (CN); Youlei JIA, Hebei (CN)

(21) Appl. No.: 17/253,049

(22) PCT Filed: Nov. 21, 2018
(86) PCT No.: PCT/CN2018/116582

§ 371 Date: Dec. 16, 2020

(30) Foreign Application Priority Data
Aug. 31, 2018 (CN) 201811011081.X

(51) Int. Cl. G06Q 10/00; G06Q 10/08; G06F 30/20

(52) U.S. Cl. CPC G06Q 10/20; G06F 2111/10; G06F 30/20; G06Q 10/087

(57) ABSTRACT

Systems and methods are disclosed for improving operation/complexity of a mechanical device maintenance system. According to one exemplary implementation, by means of calculating the remaining safe life (t01) of a warning kinematic pair, the risks associated with identifying an abnormality that is not accurately reflected in various alarm errors, including a false alarm and a missing alarm, beyond the specification, as well as loss(es) caused by an accidental shutdown accident are avoided. Further, in some embodiments, determination(s) regarding within how many days a mechanical device is not damaged and within how many days the mechanical device is undoubtedly damaged can be counted and predicted, thereby avoiding the occurrence of an urgent repair incident, and also solving the technical problem of identifying and quantifying remaining safe life, e.g., of such warning kinematic pair, devoid in the art.

### CROSS REFERENCE TO RELATED APPLICATIONS INFORMATION

The present application is a U.S. national stage patent application, pursuant to 35 U.S.C. § 371, of PCT International Application No. PCT/CN2018/116582, filed Nov. 21, 2018, published as WO2020/042386A1, and which claims priority to Chinese Application No. 201811011081.X, filed Aug. 31, 2018, published as CN109101753A, the contents of all of which are hereby incorporated by reference in their entirety.

### TECHNICAL FIELD

The present disclosure relates to a method for improving the complexity of mechanical equipment maintenance system, and especially relates to a method for improving the complexity of mechanical equipment maintenance system by means of warning the residual life of the motion pair.

### BACKGROUND ART

Existing industrialized enterprises identify faults in mechanical equipment by way of measuring physical changes e.g. in temperature, current, vibration and stress or strain. In the prior art, the approach and method, disclosed by the Chinese Patent entitled by A Method of Improving the Maintainability of Mechanical Equipment (ZL201510068431.6) and the Chinese Patent entitled by A Method of Periodical Maintenance for Improving Maintainability of Mechanical Equipment by Means of Quantitative Change (ZL201710505540.9) which further disclose a method of periodical maintenance by means of quantitative change in temperature, not only have two alarm errors, i.e. false alarm and alarm missing, but also fail to quantify the safety residual life of warning motion pair.

As a result, once an alarm is received, emergency maintenance is conducted in terms of the method which ignores cost and takes no account of saving resource. This leads to many problems, e.g. a complex matching where the number of all selected motion pairs in the mechanical equipment and the number of sensing nodes are in one to one correspondence, too costly preservation and transportation, trans-level, peer-level and crossing in repository system of spare parts from both buyer and vendor parties, and complexity and redundancy of repositories themselves, and the difficulty in meeting the requirements of the original design during maintenance in terms of the technology adopted by the original design for the mechanical equipment from the vendor and the standard parts, homemade parts and external auxiliary parts selected by the vendor.

All the above mentioned reasons account for the complexity of mechanical equipment maintenance system.

### SUMMARY

The present disclosure discloses a method for improving the complexity of mechanical equipment maintenance system, which solves the problem of improving the complexity of mechanical equipment maintenance system by solving the problems mentioned in the Background Art.

A method for improving the complexity of mechanical equipment maintenance system according to the present disclosure, comprising the steps of:

1) selecting motion pairs from a mechanical equipment:

selecting motion pairs from a mechanical equipment to be tested;

2) obtaining a residual life time period Δtₛₐₘₚₗₑ₁ of a single motion pair according to physical changes:

Δtₛₐₘₚₗₑ₁=t_{ymax1}−t_{ymin1} (1)

where

t_{ymin1} represents an initial moment when a physical change of the motion pairs starts;

t_{ymax1} represents a final moment when a physical change of the motion pairs is finished;

the initial moment of the change, t_{ymin1}, refers to a first moment of warning when the most recent physical change samples yₛₐₘₚₗₑ of the motion pairs reach an upper threshold value y₁ₘᵢₙ of confidence coefficient, wherein the upper threshold value y₁ₘᵢₙ is obtained by the following formula:

y₁ₘᵢₙ=y̅ₛₐₘₚₗₑ+k·σₛₐₘₚₗₑ (2)

where

y̅sample represents an average value of physical change data samples yₛₐₘₚₗₑ of the motion pairs;

σₛₐₘₚₗₑ represents a standard deviation of standard normal distribution of the physical change data samples yₛₐₘₚₗₑ of the motion pairs;

k represents a coefficient of standard deviation of standard normal distribution, the value of which ranges from 1 to 6;

the final moment of the change, t_{ymax1}, refers to a second moment of warning when the most recent physical change samples yₛₐₘₚₗₑ of the motion pairs, which generate the first warning, reach a design extremum y₂ₘₐₓ of physical changes of the motion pairs;

the physical changes refer to change of temperature, current, vibration and stress or strain, etc.;

wherein the approach of twice warning at both the initial moment of change and the final moment of change of the motion pairs is adopted, avoiding incidents caused by two insoluble alarm risks, i.e. false alarm and alarm missing;

3) obtaining a residual life time period Δt_{sample i} of the motion pairs in a sample group by calculation of the residual life time period Δtₛₐₘₚₗₑ₁ of the motion pairs:

Δt_{sample i}=t_{ymax1}−t_{ymin1} (3)

where

t_{ymini} represents an initial moment when physical changes of the motion pairs in the sample group start;

t_{ymaxi} represents a final moment when physical changes of the motion pairs in the sample group are finished;

4) obtaining a safety residual life time period t₀₁ of all warning motion pairs by calculation of confidence coefficient of the sample group Δt_{sample i}:

$$\begin{matrix}{t}_{01} = {\overline{t}}_{02} - k * σ & ( 4 ) \\ {\overline{t}}_{02} = \frac{1}{n} {\sum }_{j = 1}^{n} Δ {t}_{sampleij} & ( 5 ) \\ σ = \sqrt{\frac{{\sum }_{j = 1}^{n} {( Δ {t}_{sampleij} - {\overline{t}}_{02} )}^{2}}{n}} & ( 6 )\end{matrix}$$

where

t̅₀₂ represents an average value of residual life of warning motion pairs in the sample group;

n represents a capacity of the sample group and is a natural number;

σ represents a standard deviation of standard normal distribution of the sample group;

5) calculating the number of sensing nodes mₘₐₓ falling within the safety residual life time period t₀₁ of the warning motion pairs according to step 4), and conducting a simple matching where the number of warning motion pairs and the number of sensing nodes are in one to one correspondence only, which finishes secondary sensing of physical changes of warning motion pairs, replaces complex many-to-many correspondence with simple one-to-many correspondence, and thereby solves the problems of too many sensing nodes and too costly preservation and transportation;

the number of sensing nodes mₘₐₓ is calculated by the following formula:

$$\begin{matrix}{m}_{max} = \frac{{τ}_{upperexternal}}{{τ}_{internal}} \cdot {n}_{total} \cdot Cp & ( 7 ) \\ {τ}_{upperexternal} = \frac{1}{\sqrt{2 π}} {\int }_{k σ - Cp σ}^{k σ} exp ( - \frac{{z}^{2}}{2} ) dz & ( 8 ) \\ {τ}_{upperexternal} = {τ}_{γ} + {τ}_{α} + {τ}_{β} & ( 9 ) \\ {τ}_{α} = {τ}_{β} \cdot ( Cp - 1 ) & ( 10 ) \\ {τ}_{internal} = 2 \times \frac{1}{\sqrt{2 π}} {\int }_{- k σ}^{0 k σ} exp ( - \frac{{z}^{2}}{2} ) dz & ( 11 ) \\ {z}_{standard} = ( Δ {t}_{samplei} - {\overline{t}}_{02} ) / σ & ( 12 )\end{matrix}$$

where

nₜₒₜₐₗ represents the number of selected motion pairs on the mechanical equipment to be tested;

τ_{upper external} represents defect probability density of the portion drifting beyond an upper specification limit when an actual specification center does not coincide with a drift center, i.e. defect probability density falling within the safety residual life t₀₁ of the warning motion pairs;

τᵢₙₜₑᵣₙₐₗ represents defect probability density in a specification area of standard normal distribution;

τ_{γ} represents probability density of original alarms outside the specification area;

τ_{α} represents probability density of false alarm errors, also known as an error of type I;

τ_{β} represents probability density of alarm missing errors, also known as an error of type II;

Cp represents the process capability index, the value of which generally ranges from 1.33≤Cp≤1.67;

z_{standard} represents independent variable of probability density function of standard normal distribution;

6) calculating standard repository distance of spare parts s_{standard} falling within the safety residual life time period t₀₁ of the warning motion pairs according to step 4);

$$\begin{matrix}{s}_{standard} = {\overline{s}}_{sample} - k \cdot {σ}_{sample} & ( 13 ) \\ {\overline{s}}_{sample} = \frac{1}{n} {\sum }_{i = 1}^{n} {s}_{samplei} & ( 14 ) \\ {σ}_{sample} = \sqrt{\frac{{\sum }_{i = 1}^{n} {( Δ {t}_{samplei} - {\overline{s}}_{sample} )}^{2}}{n}} & ( 15 ) \\ {s}_{sample} = {t}_{sample} \cdot Vmt & ( 16 )\end{matrix}$$

where

sₛₐₘₚₗₑ represents a repository distance between defective parts and spare parts falling within the safety residual life time period t₀₁ of the warning motion pairs, also known as the repository distance of spare parts;

tₛₐₘₚₗₑ represents a statistical sample of transportation period of spare parts falling within the safety residual life time period t₀₁ of the warning motion pairs;

vₘₜ represents an average speed of mixed transportation of spare parts falling within the safety residual life time period t₀₁ of the warning motion pairs;

s̅ₛₐₘₚₗₑ represents an average value of repository distances of spare parts falling within the safety residual life time period t₀₁ of the warning motion pairs;

σₛₐₘₚₗₑ represents a standard deviation of standard normal distribution of a sample group for repository distances of spare parts falling within the safety residual life time period t₀₁ of the warning motion pairs.

the repository distance of spare parts s_{actual} should be made smaller than or equal to the standard repository distance s_{standard}, so as to realize the optimization in which burden of original design is alleviated and redesign is simplified, and solve the problem of complexity and redundancy or the like existing in the current repositories.

The present disclosure has the following beneficial effects over the prior art.

First, by means of calculating the safety residual life t₀₁ of warning motion pairs, it avoids losses caused by looking for nonexistent anomalies due to two alarm errors, i.e. false alarm and alarm missing outside the specification, and caused by fault shutdown incident. Second, it solves the problem that the prior art fails to quantify the safety residual life of warning motion pairs, that is, it is possible to predict by statistics that within how many days will the mechanical equipment stay good and within how many days will the mechanical equipment definitely break down, and thus avoid the occurrence of emergency maintenance event. Third, by means of calculating the number of sensing nodes mₘₐₓ, it realizes the simple matching where the number of warning motion pairs and the number of sensing nodes are in one to one correspondence. By employing one instead of many, simplicity instead of complexity, it solves the problem of complicated sensing nodes and too costly preservation and transportation in the prior art. Fourth, by means of calculating the standard repository distance of spare parts s_{standard}, it realizes standardizing the configuration of repository system and solves the problem of complex and redundant repositories of spare parts for mechanical equipment from both buyer and vendor parties in the prior art. Fifth, it satisfies the requirements of the original design in the maintenance process. The present disclosure improves the complexity of mechanical equipment maintenance system.

### BRIEF DESCRIPTION OF DRAWINGS

FIG. 1 is a schematic diagram showing the residual life of a warning motion pair;

FIG. 2 is a schematic diagram showing the probability densities of original alarm, false alarm and alarm missing;

FIG. 3 is a schematic diagram showing the complexity of repository of spare parts and the requirements of original design.

In the figures, 1 represents the repositories of spare parts from three parties, i.e. the buyer, the vendor and the middleman (not buying or selling); 2 represents the secondary repository; 3 represents the tertiary repository; 4 represents the quaternary repository; LSL represents the upper specification limit; SL represents the specification center; USL represents the lower specification limit.

### DETAILED DESCRIPTION OF EMBODIMENTS

Preferred embodiments of the present disclosure are provided below with reference to the drawings. What is revealed merely shows the better embodiments of the present disclosure and certainly cannot be used to define the scope of protection of the present disclosure. Therefore, equivalent variations made based on the claims of the present disclosure are still within the scope covered by the present disclosure.

### Embodiment 1

1. Selecting motion pairs from a mechanical equipment

316 motion pairs to be tested were selected from the mechanical equipment in the production system of a power generation limited company in Liaoning, in which case 24 pieces of mechanical equipment were involved.

2. Obtaining a residual life time period Δt_{sample 1} of a single motion pair according to physical changes:

First, with the help of a platform where three sides, i.e. “Internet+” source side, server side and client side, are interconnected and intercommunicated, the selected motion pairs were monitored or detected for temperature change, and after removing the abnormal data, the upper threshold value y₁ₘᵢₙ of its confidence coefficient was calculated by formula 2. The moment, when recent temperature change samples yₛₐₘₚₗₑ of the motion pairs reached the upper threshold value y₁ₘᵢₙ of the confidence coefficient, was recorded as the first warning moment t_{ymin1}. Second, the motion pairs which already gave the first warning were further monitored or detected for current change by current mutual inductance technology. The moment, when the current change reached the design extremum y₂ₘₐₓ, was recorded as the second warning moment t_{ymax1}. At last, the residual life time period Δtₛₐₘₚₗₑ₁ of a single motion pair was obtained according to formula 1 (see FIG. 1).

3. Obtaining Δt_{sample i} of a sample group by the way of obtaining the residual life time period Δtₛₐₘₚₗₑ₁ of the motion pairs;

Within the time period from the beginning of April, 2015 to the end of December, 2016 Δt_{sample i} of the sample group was obtained by the way of obtaining the residual life time period Δtₛₐₘₚₗₑ₁ of a single motion pair according to formula 3.

4. Calculating the safety residual life time period t₀₁ of warning motion pairs:

By means of confidence coefficient, the present embodiment is based on the “±kσ principle” commonly used in current projects, in which case k was taken as 3, and the safety residual life t₀₁ of warning motion pairs was calculated by formulae 4, 5 and 6, as follows:

t₀₂=20.50

σ=4.00

t₀₁=8.50≈8 days

This solves the problem that the prior art fails to quantify the safety residual life of warning motion pairs. That is, it is possible to predict by statistics that the mechanical equipment will stay good within 8 days and will definitely break down within 32 days.

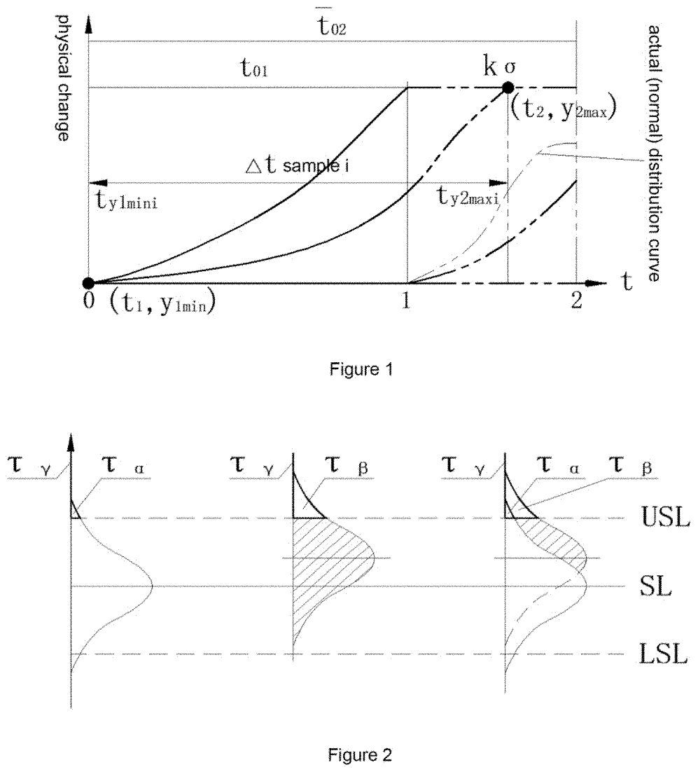

5. Calculating the number of sensing nodes mₘₐₓ falling within the safety residual life time period t₀₁=8 days of warning motion pairs according to step 4) (see FIG. 2). Motion pairs in a total number nₜₒₜₐₗ=316 were selected from the mechanical equipment to be tested in the present embodiment. In the long-run calculation process, in terms of 6a management concept and management mode, according to experimental experience, the process capability index Cp in the present embodiment was taken as 1.33, and the probability density of original alarms τ_{γ} outside the specification area from LSL to USL was ignored and thus taken as 0. By means of formulae 7, 8, 11 and 12, the calculation result of the number of its sensing nodes mₘₐₓ is as follows:

mₘₐₓ=54.98≈55

As can be known further from the calculation by formulae 9 and 10, the number of false alarm defects determined by the error probability density τ_{α} of false alarms is about 9.

In the present embodiment, the proportion of sensing nodes was reduced by a ratio of 55:316. By employing one instead of many, simplicity instead of complexity, for example 55 sensing nodes, when apportioned by the total design life limit of mechanical equipment, may be further reduced.

6. Calculating standard repository distance of spare parts s_{standard} falling within the safety residual life time period t₀₁ of the warning motion pairs according to step 4):

By means of confidence coefficient, according to the statistical sample tₛₐₘₚₗₑ of transportation period of spare parts falling within the safety residual life time period t₀₁ of warning motion pairs, average transportation speed vₘₜ and repository distance sₛₐₘₚₗₑ provided by the manufacturer, the standard repository distance s_{standard} was calculated according to formulae 13, 14, 15 and 16, the results are as follows:

s̅ₛₐₘₚₗₑ=3584 km

σₛₐₘₚₗₑ=394 km

s_{standard}=2402 km

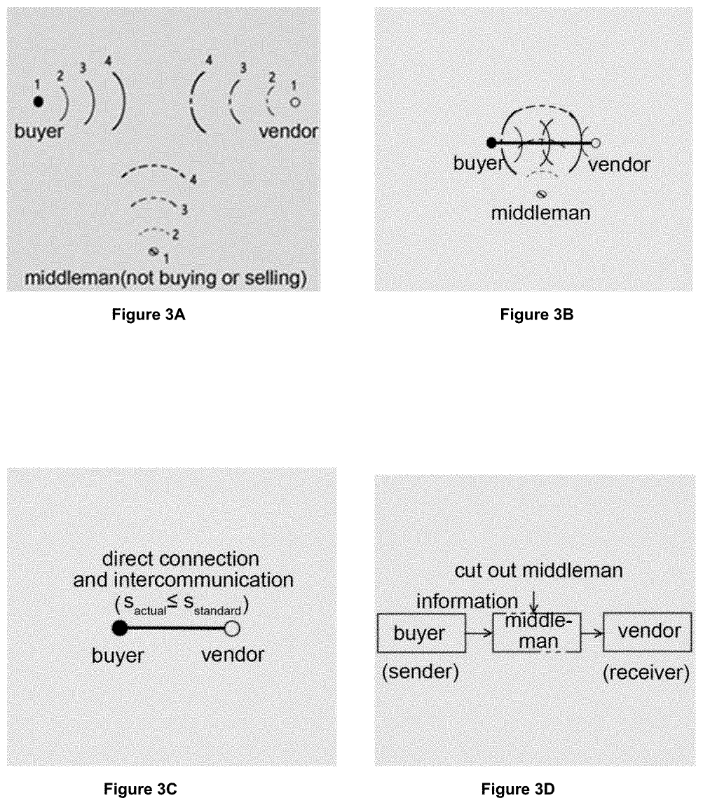

As the original repositories of spare parts of the above company all fall within the range of its standard repository distance s_{standard}=2402 km, see table 1 for example, all of them are adopted the way of direct connection and intercommunication (see FIG. 3c). All the middleman repositories involved by both buyer and vendor parties within the range of 2402 km may be cut out according to the optimization principle in which burden of original design is alleviated and redesign is simplified (see FIG. 3d).

The middleman repositories refer to secondary, tertiary and quaternary repositories or the like, as shown in FIGS. 3a and b.

TABLE 1
Comparison table of repository distance
of spare parts and their storage standard

| | Repository distance | | |
|---|---|---|---|
| Description of | of spare | | |
| spare parts | parts s_{actual} | s_{actual}/s_{standard} | Conclusion |
| Left bearing | 1230 km | <1 | Cutting out |
| employed by the | | | the middleman |
| original design | | | repository |
| for the drive pulley | | | |
| of belt conveyor | | | |

. . .

### Embodiment 2

1. Selecting motion pairs from a mechanical equipment

1008 motion pairs to be tested were selected from the mechanical equipment in the production system of a thermal power plant in Jilin, in which case 37 pieces of mechanical equipment were involved.

2. Obtaining a residual life time period Δt_{sample 1} of a single motion pair according to physical changes:

First, with the help of a platform where three sides, i.e. “Internet+” source side, server side and client side, are interconnected and intercommunicated, the selected motion pairs were monitored or detected for temperature change and after removing the abnormal data, the upper threshold value y₁ₘᵢₙ of its confidence coefficient was calculated by formula 2. The moment, when recent temperature change samples yₛₐₘₚₗₑ of the motion pairs reached the upper threshold value y₁ₘᵢₙ of the confidence coefficient, was recorded as the first warning moment t_{ymin1}. Second, the motion pairs which already gave the first warning were further monitored or detected for second temperature change. The moment, when the second temperature change reached the design extremum y₂ₘₐₓ, was recorded as the second warning moment t_{ymax1}. At last, the residual life time period Δtₛₐₘₚₗₑ₁ of a single motion pair was obtained according to formula 1 (see FIG. 1).

3. Obtaining Δt_{sample i} of a sample group by the way of obtaining the residual life time period Δtₛₐₘₚₗₑ₁ of the motion pairs:

Within the time period from the beginning of April, 2017 to the end of October, 2017 Δt_{sample i} of the sample group was obtained by the way of obtaining the residual life time period Δt_{sample 1} of a single motion pair according to formula 3.

4. Calculating the safety residual life time period t₀₁ of warning motion pairs:

By means of confidence coefficient, the present embodiment is based on the “±kσ principle” commonly used in current projects, in which case k was taken as 3, and the safety residual life t₀₁ of warning motion pairs was calculated by formulae 4, 5 and 6, as follows:

t₀₂=33.20

σ=8.00

t₀₁=9.20≈9 days

This solves the problem that the prior art fails to quantify the safety residual life of warning motion pairs. That is, it is possible to predict by statistics that the mechanical equipment will stay good within 9 days and will definitely break down within 57 days.

5. Calculating the number of sensing nodes mₘₐₓ falling within the safety residual life time period t₀₁=9 days of warning motion pairs according to step 4) (see FIG. 2). Motion pairs in a total number nₜₒₜₐₗ=1008 were selected from the mechanical equipment to be tested in the present embodiment. In the long-run calculation process, in terms of 6a management concept and management mode, according to experimental experience, the process capability index Cp in the present embodiment was taken as 1.33, and the probability density of original alarms τ_{γ} outside the specification area from LSL to USL was ignored and thus taken as 0. By means of formulae 7, 8, 11 and 12, the calculation result of the number of its sensing nodes mₘₐₓ is as follows:

mₘₐₓ=175.44≈176

As can be known further from the calculation by formulae 9 and 10, the number of false alarm defects determined by the error probability density τ_{α} of false alarms is about 43.

In the present embodiment, the proportion of sensing nodes was reduced by a ratio of 176:1008. By employing one instead of many, simplicity instead of complexity, for example 176 sensing nodes, when apportioned by the total design life limit of mechanical equipment, may be further reduced.

6. Calculating standard repository distance of spare parts s_{standard} falling within the safety residual life time period t₀₁ of the warning motion pairs according to step 4):

By means of confidence coefficient, according to the statistical sample tₛₐₘₚₗₑ of transportation period of spare parts falling within the safety residual life time period t₀₁ of warning motion pairs, average transportation speed vₘₜ and repository distance sₛₐₘₚₗₑ provided by the manufacturer, the standard repository distance s_{standard} was calculated according to formulae 13, 14, 15 and 16, the results are as follows:

s̅ₛₐₘₚₗₑ=4111 km

σₛₐₘₚₗₑ=434 km

s_{standard}=2809 km

As the original repositories of spare parts of the above company all fall within the range of its standard repository distance s_{standard}=2809 km, see table 2 for example, all of them are adopted the way of direct connection and intercommunication (see FIG. 3c). All the middleman repositories involved by both buyer and vendor parties within the range of 2809 km may be cut out according to the optimization principle in which burden of original design is alleviated and redesign is simplified (see FIG. 3d).

TABLE 2
Comparison table of repository distance
of spare parts and their storage standard

| | Repository distance | | |
|---|---|---|---|
| Description of | of spare | | |
| spare parts | parts s_{actual} | s_{actual}/s_{standard} | Conclusion |
| Right bearing | 2415 km | <1 | Cutting out |
| employed by the | | | the middleman |
| original design | | | repository |
| for crusher | | | |

. . .

### Embodiment 3

1. Selecting motion pairs from a mechanical equipment

2498 motion pairs to be tested were selected from the mechanical equipment in the production system of a harbor limited company in Hebei, in which case 43 pieces of mechanical equipment were involved.

2. Obtaining a residual life time period Δtₛₐₘₚₗₑ₁ of a single motion pair according to physical changes:

First, with the help of a platform where three sides, i.e. “Internet+” source side, server side and client side, are interconnected and intercommunicated, the selected motion pairs were monitored or detected for vibration change, and after removing the abnormal data, the upper threshold value y₁ₘᵢₙ of its confidence coefficient was calculated by formula 2. The moment, when recent vibration change samples yₛₐₘₚₗₑ of the motion pairs reached the upper threshold value y₁ₘᵢₙ of the confidence coefficient, was recorded as the first warning moment t_{ymin1}. Second, the motion pairs which already gave the first warning were further monitored or detected for second vibration change. The moment, when the second vibration change reached the design extremum y₂ₘₐₓ, was recorded as the second warning moment t_{ymax1}. At last, the residual life time period Δtₛₐₘₚₗₑ₁ of a single motion pair was obtained according to formula 1 (see FIG. 1).

3. Obtaining Δt_{sample i} of a sample group by the way of obtaining the residual life time period Δtₛₐₘₚₗₑ₁ of the motion pairs;

Within the time period from the beginning of February, 2018 to the end of August, 2018, Δt_{sample i} of the sample group was obtained by the way of obtaining the residual life time period Δtₛₐₘₚₗₑ₁ of a single motion pair according to formula 3.

4. Calculating the safety residual life time period t₀₁ of warning motion pairs:

By means of confidence coefficient, the present embodiment is based on the “±kσ principle” commonly used in current projects, in which case k was taken as 3, and the safety residual life t₀₁ of warning motion pairs was calculated by formulae 4, 5 and 6, as follows:

t₀₂=20.30

σ=2.80

t₀₁=11.90≈12 days

This solves the problem that the prior art fails to quantify the safety residual life of warning motion pairs. That is, it is possible to predict by statistics that the mechanical equipment will stay good within 12 days and will definitely break down within 28.7 days.

5. Calculating the number of sensing nodes mₘₐₓ falling within the safety residual life time period t₀₁=12 days of warning motion pairs according to step 4) (see FIG. 2). Motion pairs in a total number nₜₒₜₐₗ=2498 were selected from mechanical equipment to be tested in the present embodiment. In the long-run calculation process, in terms of 6a management concept and management mode, according to experimental experience, the process capability index Cp in the present embodiment was taken as 1.33, and the probability density of original alarms τ_{γ} outside the specification area from LSL to USL was ignored and thus taken as 0. By means of formulae 7, 8, 11 and 12, the calculation result of the number of its sensing nodes mₘₐₓ is as follows:

mₘₐₓ=434.77≈435

As can be known further from the calculation by formulae 9 and 10, the number of false alarm defects determined by the error probability density τ_{α} of false alarms is about 108.

In the present embodiment, the proportion of sensing nodes was reduced by a ratio of 435:2498. By employing one instead of many, simplicity instead of complexity, for example 176 sensing nodes, when apportioned by the total design life limit of mechanical equipment, may be further reduced.

6. Calculating standard repository distance of spare parts s_{standard} falling within the safety residual life time period t₀₁ of the warning motion pairs according to step 4):

By means of confidence coefficient, according to the statistical sample tₛₐₘₚₗₑ of transportation time period of spare parts falling within the safety residual life time period t₀₁ of warning motion pairs, average transportation speed vₘₜ and repository distance sₛₐₘₚₗₑ provided by the manufacturer, the standard repository distance s_{standard} was calculated according to formulae 13, 14, 15 and 16, the results are as follows.

s̅sₐₘₚₗₑ=8583 km

σₛₐₘₚₗₑ=394 km

s_{standard}=7401 km

As the original repositories of spare parts of the above company all fall within the range of its standard repository distance s_{standard}=7401 km, see table 3 for example, all of them are adopted the way of direct connection and intercommunication (see FIG. 3c). All the middleman repositories involved by both buyer and vendor parties within the range of 7401 km may be cut out according to the optimization principle in which burden of original design is alleviated and redesign is simplified (see FIG. 3d).

TABLE 3
Comparison table of repository distance
of spare parts and their storage standard

| | Repository distance | | |
|---|---|---|---|
| Description of | of spare | | |
| spare parts | parts s_{actual} | s_{actual}/s_{standard} | Conclusion |
| Bearing seat for the | 6415 km | <1 | Cutting out |
| slave roller of the | | | the middleman |
| cantilever of ship | | | repository |
| loader | | | |

. . .

The following beneficial effects are produced during implementing the present disclosure at the power generation limited company in Liaoning, the thermal power plant in Jilin and the harbor limited company in Heibei:

First, by means of obtaining the initial moment of the change t_{ymin1} sample and the final moment of the change t_{ymax1} sample incurred by physical changes of the motion pairs, it avoids losses caused by looking for nonexistent anomalies due to two alarm errors, i.e. false alarm and alarm missing outside the specification, and caused by fault shutdown incident in the above three enterprises.

Second, by means of calculating the safety residual life t₀₁ of warning motion pairs, it solves the problem that the prior art used by the three enterprises fails to quantify the safety residual life of warning motion pairs, that is, it is possible to predict by statistics that within how many days will the mechanical equipment stay good and within how many days will the mechanical equipment definitely break down, and thus avoid the occurrence of emergency maintenance event.

Third, by means of calculating the number of sensing nodes mₘₐₓ, it realizes simple matching where the number of warning motion pairs and the number of sensing nodes are in one to one correspondence. By employing one instead of many, simplicity instead of complexity, it solves the problem of complicated sensing nodes and too costly preservation and transportation in the prior art used by the above three enterprises.

Fourth, by means of calculating the standard repository distance of spare parts s_{standard}, it realizes standardizing the configuration of repository system and solves the problem of complex and redundant repositories of spare parts for mechanical equipment from both buyer and vendor parties in the prior art used by the above three enterprises.

Fifth, it satisfies the requirements of the original design in the maintenance process in the above three enterprises.

The present disclosure improves the complexity of the mechanical equipment maintenance system by solving the above problems.

1. A method of improving complexity of a mechanical equipment maintenance system, comprising steps of:
1) selecting motion pairs from a mechanical equipment:
selecting motion pairs from a mechanical equipment to be tested;
2) obtaining a residual life time period Δtₛₐₘₚₗₑ₁ of a single motion pair according to physical changes:
Δtₛₐₘₚₗₑ₁=t_{ymax1}−t_{ymin1} (1)
where
t_{ymin1} represents an initial moment when a physical change of the motion pairs starts;
t_{ymax1} represents a final moment when a physical change of the motion pairs is finished;
the initial moment of the change, t_{ymin1}, refers to a first moment of warning when recent physical change samples yₛₐₘₚₗₑ of the motion pairs reach an upper threshold value y₁ₘᵢₙ of confidence coefficient, wherein the upper threshold value yl min is obtained by the following formula:
y₁ₘᵢₙ=y̅ₛₐₘₚₗₑ+k·σₛₐₘₚₗₑ (2)
where
y̅ₛₐₘₚₗₑ represents an average value of physical change data samples yₛₐₘₚₗₑ of the motion pairs;
σₛₐₘₚₗₑ represents a standard deviation of standard normal distribution of the physical change data samples yₛₐₘₚₗₑ of the motion pairs;
k represents a coefficient of standard deviation of standard normal distribution, the value of which ranges from 1 to 6;
the final moment of the change, t_{ymax1}, refers to a second moment of warning when recent physical change samples yₛₐₘₚₗₑ of the motion pairs, which generate a first warning, reach a design extremum y₂ₘₐₓ of physical changes of the motion pairs;
the physical changes refer to change of temperature, current, vibration and stress or strain,
wherein the approach of twice warning at both the initial moment of change and the final moment of change of the motion pairs is adopted, avoiding incidents caused by two insoluble alarm risks, i.e. false alarm and alarm missing;
3) obtaining a residual life time period Δt_{sample i} of motion pairs in a sample group by calculation of the residual life time period Δtₛₐₘₚₗₑ₁ of the motion pairs:
Δt_{sample i}=t_{ymaxi}−t_{ymini} (3)
where
t_{ymin1} represents an initial moment when physical changes of the motion pairs in the sample group start;
t_{ymax1} represents a final moment when physical changes of the motion pairs in the sample group are finished;
4) obtaining a safety residual life time period t₀₁ of all warning motion pairs by calculation of confidence coefficient of the sample group Δt_{sample i}:
$$\begin{matrix}{t}_{01} = {\overline{t}}_{02} - k * σ & ( 4 ) \\ {\overline{t}}_{02} = \frac{1}{n} {\sum }_{j = 1}^{n} Δ {t}_{sampleij} & ( 5 ) \\ σ = \sqrt{\frac{{\sum }_{j = 1}^{n} {( Δ {t}_{sampleij} - {\overline{t}}_{02} )}^{2}}{n}} & ( 6 )\end{matrix}$$
where
t̅₀₂ represents an average value of residual life of warning motion pairs in the sample group;
n represents a capacity of the sample group and is a natural number;
σ represents a standard deviation of standard normal distribution of the sample group;
5) calculating the number of sensing nodes mₘₐₓ falling within the safety residual life time period t₀₁ of the warning motion pairs according to step 4), and conducting a simple matching where the number of warning motion pairs and the number of sensing nodes are in one to one correspondence only:
the number of sensing nodes mₘₐₓ is calculated by a following formula:
$$\begin{matrix}{m}_{max} = \frac{{τ}_{upperexternal}}{{τ}_{internal}} \cdot {n}_{total} \cdot Cp & ( 7 ) \\ {τ}_{upperexternal} = \frac{1}{\sqrt{2 π}} {\int }_{k σ - Cp σ}^{k σ} exp ( - \frac{{z}^{2}}{2} ) dz & ( 8 ) \\ {τ}_{upperexternal} = {τ}_{γ} + {τ}_{α} + {τ}_{β} & ( 9 ) \\ {τ}_{α} = {τ}_{β} \cdot ( Cp - 1 ) & ( 10 ) \\ {τ}_{internal} = 2 \times \frac{1}{\sqrt{2 π}} {\int }_{- k σ}^{0 k σ} exp ( - \frac{{z}^{2}}{2} ) dz & ( 11 ) \\ {z}_{standard} = ( Δ {t}_{samplei} - {\overline{t}}_{02} ) / σ & ( 12 )\end{matrix}$$
where
nₜₒₜₐₗ represents the number of selected motion pairs on the mechanical equipment to be tested;
τ_{upper external} represents a defect probability density of a portion drifting beyond an upper specification limit when an actual specification center does not coincide with a drift center, i.e. defect probability density falling within the safety residual life t₀₁ of the warning motion pairs;
τᵢₙₜₑᵣₙₐₗ represents a defect probability density in a specification area of standard normal distribution;
τ_{γ} represents a probability density of original alarms outside the specification area;
τ_{α} represents a probability density of false alarm errors, also known as an error of type I;
τ_{β} represents probability density of alarm missing errors, also known as an error of type II;
Cp represents a process capability index, a value of which generally ranges from 1.33≤Cp≤1.67;
z_{standard} represents an independent variable of a probability density function of standard normal distribution;
6) calculating a standard repository distance of spare parts s_{standard} falling within the safety residual life time period t₀₁ of the warning motion pairs according to step 4):
$$\begin{matrix}{s}_{standard} = {\overline{s}}_{sample} - k \cdot {σ}_{sample} & ( 13 ) \\ {\overline{s}}_{sample} = \frac{1}{n} {\sum }_{i = 1}^{n} {s}_{samplei} & ( 14 ) \\ {σ}_{sample} = \sqrt{\frac{{\sum }_{i = 1}^{n} {( Δ {t}_{samplei} - {\overline{s}}_{sample} )}^{2}}{n}} & ( 15 ) \\ {s}_{sample} = {t}_{sample} \cdot Vmt & ( 16 )\end{matrix}$$
where
sₛₐₘₚₗₑ represents a repository distance between defective parts and spare parts falling within the safety residual life time period t₀₁ of the warning motion pairs, also known as a repository distance of spare parts;
tₛₐₘₚₗₑ represents a statistical sample of transportation period of the spare parts falling within the safety residual life time period t₀₁ of the warning motion pairs;
vₘₜ represents an average speed of mixed transportation of the spare parts falling within the safety residual life time period t₀₁ of the warning motion pairs;
s̅ₛₐₘₚₗₑ represents an average value of the repository distances of the spare parts falling within the safety residual life time period t₀₁ of the warning motion pairs;
σₛₐₘₚₗₑ represents a standard deviation of standard normal distribution of a sample group for the repository distances of the spare parts falling within the safety residual life time period t₀₁ of the warning motion pairs;
the repository distance of the spare parts s_{actual} is made smaller than or equal to the standard repository distance s_{standard}, so as to realize an optimization in which burden of original design is alleviated and redesign is simplified.
